(19) United States
(12) Patent Application Publication
(10) Pub. No.: US 2021/0254716 A1
(43) Pub. Date: Aug. 19, 2021

(54) FLEXIBLE CRYOGENIC SEAL

(71) Applicant: SAINT-GOBAIN PERFORMANCE PLASTICS CORPORATION, Solon, OH (US)

(72) Inventors: Philippe BURLOT, Le Quillio (FR); Shabarish NUNNA, Antwerp (BE); Herman M. DUBOIS, Duffel (BE)

(21) Appl. No.: 17/176,548

(22) Filed: Feb. 16, 2021

Related U.S. Application Data
(60) Provisional application No. 62/978,476, filed on Feb. 19, 2020.

(51) Int. Cl. F16J 15/3204

(52) U.S. Cl. CPC F16J 15/3204

(57) ABSTRACT

Systems and methods are disclosed that include providing a valve suitable for maintaining a seal and preventing fluid flow through the valve at cryogenic temperatures. The valve includes a valve body, a ball selectively rotatable within the valve body, a seat having a seat insert at disposed within the valve body and configured to form a seal with the ball, and a seal disposed within a cavity formed between the valve body and the seat. The seal includes a seal body having a heel, an upper leg and a lower leg extending from the heel, and a cavity comprising a first cavity portion and a second cavity portion disposed between the upper leg and the lower leg. The first cavity portion includes at least one energizing element, and the second cavity portion may be free of an energizing element or include an energizing element.

### CROSS-REFERENCE TO RELATED APPLICATIONS

This application claims priority under 35 U.S.C. § 119(e) to U.S. Provisional Application No. 62/978,476, entitled “FLEXIBLE CRYOGENIC SEAL,” by Philippe BURLOT et al., filed on Feb. 19, 2020, which is assigned to the current assignee hereof and incorporated herein by reference in its entirety for all purposes.

### BACKGROUND OF THE INVENTION

Valves are used to control the flow of fluids in a wide range of applications. Ball valves are typically used in applications where interruption of the flow of fluid through the ball valve is required. The interruption and establishment of fluid flow through the ball valve is accomplished via selective actuation of a ball within the ball valve. Seals within the ball valve may be used between ball valve components to control relative motion between such ball valve components to aid in controlling fluid flow through the ball valve. However, when a ball valve is subjected to extreme environmental conditions such as cryogenic temperatures, ball valve components may shrink, deform, or otherwise translate shift, thereby allowing leakage of the fluid through the ball valve. Accordingly, the industry continues to demand improvements in ball valve technology for such applications.

### SUMMARY

Embodiments of the present invention relate in general to a valve having an annular seal that accommodates and/or compensates for hardware deformations in the valve that result from the valve being operated in or subjected to extreme environmental conditions such as at cryogenic temperatures. Embodiments of a seal may include a seal body, comprising: a heel; an upper leg and a lower leg each extending from the heel; and a cavity formed between the upper leg and the lower leg and comprising a first cavity portion and a second cavity portion; and an energizing element disposed within the first cavity portion. Embodiments of a valve may include a valve body; a ball selectively rotatable within the valve body; a seat having a seat insert disposed within the valve body and configured to form a seal with the ball; and a seal disposed within a cavity formed between the valve body and the seat, wherein the seal comprises: a seal body, comprising: a heel; an upper leg and a lower leg extending from the heel; and a cavity comprising a first cavity portion and a second cavity portion disposed between the upper leg and the lower leg; and an energizing element disposed within the first cavity portion.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a partial cross-sectional view of a valve according to an embodiment of the disclosure.

FIG. 2 is a partial cross-sectional view of a seal according to an embodiment of the disclosure.

FIG. 3 shows a graph of the contact pressures of the embodiments of the seal of FIGS. 1 and 2.

FIG. 4A shows the leak performance data for multiple tests of an embodiment of a seal for the aligned condition.

FIG. 4B shows the leak performance data for multiple tests of an embodiment of a seal for a 0.2 mm misaligned condition.

FIG. 4C shows the leak performance data for multiple tests of an embodiment of a seal for a 0.3 mm misaligned condition.

The use of the same reference symbols in different drawings indicates similar or identical items.

### DETAILED DESCRIPTION

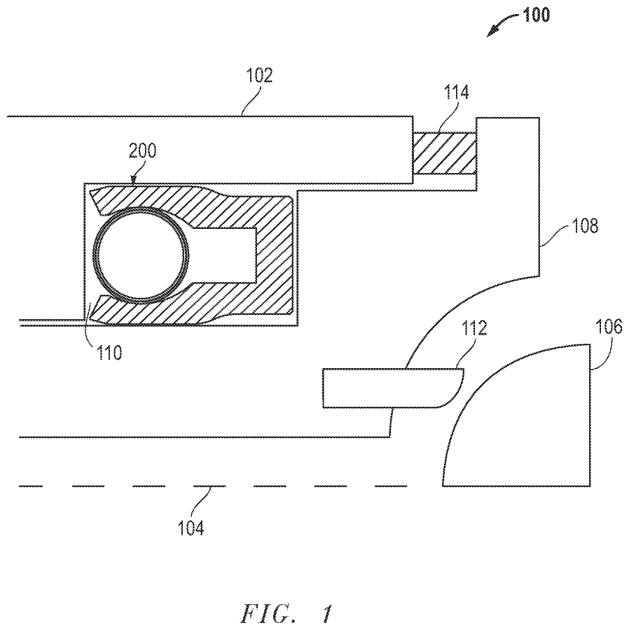

FIG. 1 shows a partial cross-sectional view of a valve 100 according to an embodiment of the disclosure. In some embodiments, valve 100 may comprise a ball valve. However, in other embodiments, valve 100 may comprise any other suitable valve. Valve 100 may generally comprise a valve body 102 having a longitudinal axis 104 along a flow path through the valve 100 and a ball 106 selectively rotatable within the valve body 102 to selectively allow fluid flow along the flow path and through the valve 100. Valve 100 may also comprise a seat 108 having a seat insert 112 that may generally be designed to prevent leakage of a fluid through a leakage path when the ball 106 is selectively rotated to prevent fluid flow along the flow path and through the valve 100. In some embodiments, a cavity 110 may be formed between the valve body 102 and the seat 108. Additionally, in some embodiments, the valve 100 may also comprise one or more springs 114 configured to bias the seat 108 away from the valve body 102 and towards the ball 106 to selectively maintain a fluid tight seal between the seat insert 112 and the ball 106. Furthermore, in some embodiments, the valve 100 may also comprise one or more seals 200.

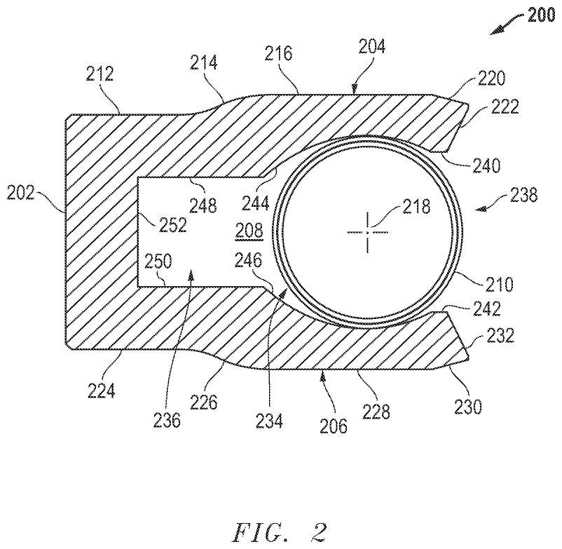

FIG. 2 shows a partial cross-sectional view of a seal 200 according to an embodiment of the disclosure. Seal 200 may generally be configured to accommodate and/or compensate for hardware deformations in the valve 100 that result when the valve 100 is operated in extreme environmental conditions such as at cryogenic temperatures. Seal 200 may generally comprise a heel 202, an upper leg 204 extending from the heel 202, a lower leg 206 extending from the heel 202, a cavity 208 formed between the upper leg 204 and the lower leg 206, and an energizing element 210. The heel 202 may generally comprise a base and/or vertical structure of the seal 200. In some embodiments, the heel 202 may form an inner diameter of the seal 200. In other embodiments, the heel 202 may form an outer diameter of the seal 200. Accordingly, in some embodiments, the heel 202 may seat against the valve body 102 of the valve 100. In other embodiments, the heel 202 may seat against the seat 108 of the valve 100. In alternative embodiments, the heel 202 may seat against other components of the valve 100 depending on the configuration of the valve 100.

The upper leg 204 may generally extend from an upper end of the heel 202. In some embodiments, the upper leg 204 may extend orthogonally from the upper end of the heel 202. In other embodiments, the upper leg 204 may extend at an acute or obtuse angle from the upper end of the heel 202 (e.g., 5 degrees, 10 degrees, etc.). The upper leg 204 may generally comprise an outer upper surface 212 that extends from the heel 202, a radial transition 214, and an outer upper contact surface 216. In some embodiments, the radial transition 214 may comprise multiple radial curves that join the outer upper surface 212 and the outer upper contact surface 216. In some embodiments, the outer upper surface 212 and the outer upper contact surface 216 may be substantially parallel. In some embodiments, the outer upper contact surface 216 may comprise a larger vertical height from a center 218 of the energizing element 210 than does the outer upper surface 212 from the center 218 of the energizing element 210. Thus, the seal 200 may comprise a larger overall vertical height measured at the outer upper contact surface 216 as compared the vertical height measured at the outer upper surface 212. It will further be appreciated that in some embodiments, the outer upper contact surface 216 may remain in contact with the valve body 102, the seat 108, and/or another component of the valve 100 during operation to stabilize the components of the valve 100 and accommodate and/or compensate for hardware deformations in the valve 100 that result when the valve 100 is operated. Further, in some embodiments, the upper leg 204 may comprise a bevel 220 at an end of the outer upper contact surface 216. Still further, in some embodiments, the upper leg 204 may comprise an end surface 222 extending from the bevel 220. In some embodiments, the end surface 222 may angle inwards towards the center 218 of the energizing element 210. However, in other embodiments, the end surface 222 may be substantially vertical.

The lower leg 206 may generally extend from a lower end of the heel 202. In some embodiments, the lower leg 206 may extend orthogonally from the lower end of the heel 202. In other embodiments, the lower leg 206 may extend at an acute or obtuse angle from the lower end of the heel 202 (e.g., 5 degrees, 10 degrees, etc.). The lower leg 206 may generally comprise an outer lower surface 224 that extends from the heel 202, a radial transition 226, and an outer lower contact surface 228. In some embodiments, the radial transition 226 may comprise multiple radial curves that join the outer lower surface 224 and the outer lower contact surface 228. In some embodiments, the outer lower surface 224 and the outer lower contact surface 228 may be substantially parallel. In some embodiments, the outer lower contact surface 228 may comprise a larger vertical height from the center 218 of the energizing element 210 than does the outer lower surface 224 from the center 218 of the energizing element 210. Thus, the seal 200 may comprise a larger overall vertical height measured at the outer lower contact surface 228 as compared the vertical height measured at the outer lower surface 224. It will further be appreciated that in some embodiments, the outer lower contact surface 228 may remain in contact with the valve body 102, the seat 108, and/or another component of the valve 100 during operation to stabilize the components of the valve 100 and accommodate and/or compensate for hardware deformations in the valve 100 that result when the valve 100 is operated. Further, in some embodiments, the lower leg 206 may comprise a bevel 230 at an end of the outer lower contact surface 228. Still further, in some embodiments, the lower leg 206 may comprise an end surface 232 extending from the bevel 230. In some embodiments, the end surface 232 may angle inwards towards the center 218 of the energizing element 210. However, in other embodiments, the end surface 232 may be substantially vertical.

The cavity 208 may generally be formed between the upper leg 204 and the lower leg 206 and comprise a first cavity portion 234 and a second cavity portion 236. The first cavity portion 234 may generally comprise an opening 238 defined between an upper opening surface 240 that extends from the upper end surface 222 of the upper leg 204 and a lower opening surface that extends from the lower end surface 232 of the lower leg 206. In some embodiments, the opening surfaces 240, 242 may be substantially horizontal and/or parallel to each other. However, in other embodiments, the opening surfaces 240, 242 may comprise any other non-horizontal orientation and/or may comprise different dimensions. The first cavity portion 234 may also comprise an upper curved surface 244 extending from the upper opening surface 240 and a lower curved surface 246 extending from the lower opening surface 242. The curved surfaces 244, 246 may extend from the opening surfaces 240, 242, respectively, and truncate at and be open to the second cavity portion 236. In some embodiments, the curved surfaces 244, 246 may be symmetrical about a horizontal centerline that extends through the center 218 of the energizing element 210. Thus, it will be appreciated that the curved surfaces 244, 246 may comprise substantially equal radii and/or substantially equal curve lengths. Furthermore, the first cavity portion 234 may be configured to receive the energizing element 210 and capture the energizing element 210 between the upper curved surface 244 and the lower curved surface 246. Thus, it will be appreciated that the curved surfaces 244, 246 may comprise a larger radius than that of the energizing element 210.

The second cavity portion 236 may generally be formed between the first cavity portion 234 and the heel 202. The second cavity portion 236 may generally comprise an upper surface 248, an opposing lower surface 250, and a vertical wall 252 disposed between the upper surface 248 and the lower surface 250 and opposite the opening 238 of the first cavity portion 234. While the first cavity portion 234 comprises the energizing element 210, the second cavity portion 236 may be free of an energizing element 210. In alternative embodiments, the second cavity portion 236 may comprise an energizing element 210, a spring, or any combination thereof, and the surfaces 248, 250 may comprise a profile substantially similar to that of the curved surfaces 244, 246. The upper surface 248 may extend towards the heel 202 from the upper curved surface 244 to the vertical wall 252. The lower surface 250 may extend towards the heel 202 from the lower curved surface 246 to the vertical wall 252. In some embodiments, the upper surface 248 and the lower surface 250 may comprise substantially equal lengths. In some embodiments, the upper surface 248 and the lower surface 250 may be substantially parallel. However, in other embodiments, the upper surface 248 and the lower surface 250 may be angled or curved with respect to the horizontal centerline that extends through the center 218 of the energizing element 210. Additionally, in some embodiments, the vertical wall 252 may be substantially parallel to the heel 202 of the seal 200 and orthogonal to each of the upper surface 248 and the lower surface 250. However, in other embodiments, the vertical wall 252 may comprise any other profile (e.g., including one or more non-vertical elements). Thus, it will be appreciated that in some embodiments, the second cavity portion 236 may comprise a substantially rectangular or square cross-sectional profile. Further, in some embodiments, a chamfer and/or radius may be present between the vertical wall 252 and each of the upper surface 248 and the lower surface 250. However, in other embodiments, the second cavity portion 236 may comprise any other shaped profile (e.g., oval, rounded having similar or dissimilar radii, trapezoidal, symmetrical, non-symmetrical, or any combination of various features and/or profiles).

The energizing element 210 may generally comprise a spring and be disposed within the first cavity portion 234 between the upper curved surface 244 and the lower curved surface 246. The energizing element 210 may be configured to bias the upper leg 204 and the lower leg 206 away from each other to maintain contact between the outer upper contact surface 216 and the valve body 102, the seat 108, and/or another component of the valve 100 and the outer lower contact surface 228 and the valve body 102, the seat 108, and/or another component of the valve 100. Accordingly, the energizing element may conform to one or more curved surfaces 244, 246 in response to deformation or misalignment in the valve 100 caused by operation of the valve 100. In some embodiments, the energizing element 210 may comprise a circular profile. However, in other embodiments, the spring may comprise another profile, such as an oval-shaped profile, a U-shaped profile, a V-shaped profile, or any other shaped profile. In some embodiments, the energizing element 210 may comprise a single layer of material. However, in other embodiments, the energizing element 210 may comprise multiple layers or plies of material. Suitable materials for the energizing element 210 may include, for example, titanium, stainless steel, steel, Inconel®, Elgiloy®, Hastelloy®, other resilient metallic materials, or any combination thereof. Furthermore, the seal body (comprising all components of the seal 200 without the energizing element 210) may be formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof.

Still referring to FIG. 2, the seal may generally be substantially symmetrical about the horizontal centerline that extends through the center 218 of the energizing element 210. The seal 200 may also comprise a larger overall height as measured between the upper contact surface 216 and the lower contact surface 228 as compared to the overall height measured between the upper surface 212 and the lower surface 224. It will be appreciated that the overall height of the first cavity portion 234 as measured between the upper curved surface 244 and the lower curved surface 246 may be larger than the overall height of the second cavity portion 236 as measured between the upper surface 248 and the lower surface 250. Further, the overall height of the opening 238 as measured between the upper opening surface 240 and the lower opening surface 242 may be larger than the overall height of the second cavity portion 236 as measured between the upper surface 248 and the lower surface 250.

The second cavity portion 236 may comprise a horizontal length or depth as measured by the horizontal length of the upper surface 248 and/or the lower surface 250 of the second cavity portion 236. The depth of the second cavity portion 236 may comprise a percentage of the depth of the first cavity portion 234 as measured along the horizontal centerline that extends through the center 218 of the energizing element 210. In some embodiments, the depth of the second cavity portion 236 may be at least 25%, at least 50%, at least 55%, at least 60%, at least 65%, at least 70%, at least 75%, at least 80%, at least 90%, at least 95%, or at least 100% of the depth of the first cavity portion 234. In some embodiments, the depth of the second cavity portion 236 may be not greater than 200%, not greater than 150%, not greater than 125%, or not greater than 100% of the depth of the first cavity portion 234. Further, it will be appreciated that the depth of the second cavity portion 236 may be between any of these minimum and maximum values, such as at least 25% and not greater than 200% of the depth of the first cavity portion 234.

The depth of the second cavity portion 236 may also comprise a percentage of the overall length of the seal 200 as measured along the horizontal centerline that extends through the center 218 of the energizing element 210. In some embodiments, the depth of the second cavity portion 236 may be at least 5%, at least 10%, at least 15%, at least 20%, at least 30%, at least 35%, or at least 40% of the overall length of the seal 200. In some embodiments, the depth of the second cavity portion 236 may be not greater than 80%, not greater than 75%, not greater than 70%, not greater than 65%, not greater than 60%, not greater than 55%, not greater than 50%, not greater than 45%, or not greater than 40% of the overall length of the seal 200. Further, it will be appreciated that the depth of the second cavity portion 236 may be between any of these minimum and maximum values, such as at least 5% and not greater than 80% of the overall length of the seal 200.

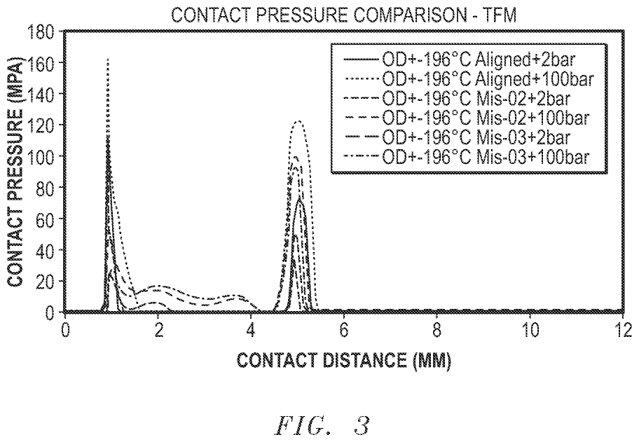

FIG. 3 shows a graph of the contact pressures (contact pressure profile) of embodiments of the seal 200 in an aligned condition, a 0.2 mm misaligned condition, and a 0.3 mm misaligned condition. As shown, it can be seen that the major impact of the misalignment is on the maximal load of each peak. The main difference between aligned and misaligned is that, during pressurization, the two peaks are merging (i.e. the sealing path becomes continuous) for a misaligned condition. The lower contact pressure is then compensated by a longer contact length. Thus, as a result, the seal 200 increases contact pressure between the contact surfaces 216, 228 of the seal 200 and the components of the valve 100. In some embodiments, as compared to a traditional seal without a second cavity portion 236, seal 200 having a second cavity portion 236 may increase a contact pressure at each of the contact surfaces 216, 228 and/or sealing force between the seal 200 and components of the valve 100. In some embodiments, the seal 200 may increase the contact pressure and/or the sealing force by at least 5%, at least 10%, at least 15%, at least 20%, at least 25%, at least 30%, at least 35%, at least 40%, at least 45%, at least 50%, at least 75%, at least 95%, at least 100%, at least 125%, or at least 150%. In some embodiments, the seal 200 may increase the contact pressure and/or the sealing force by not greater than 500%, not greater than 400%, not greater than 300%, not greater than 200%, or not greater than 100%. Further, it will be appreciated that the seal 200 may increase the contact pressure and/or the sealing force by between any of these minimum and maximum values, such as at least 5% and not greater than 500%.

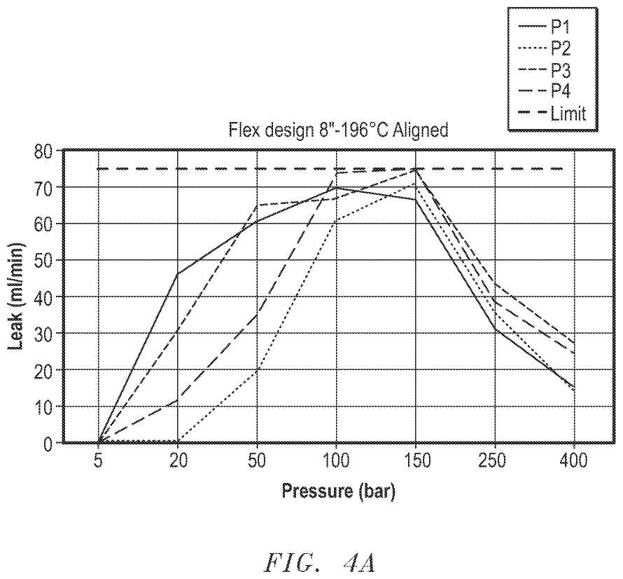

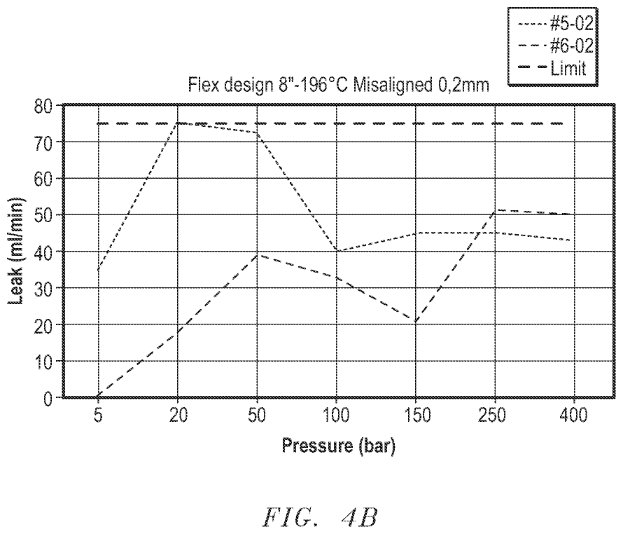

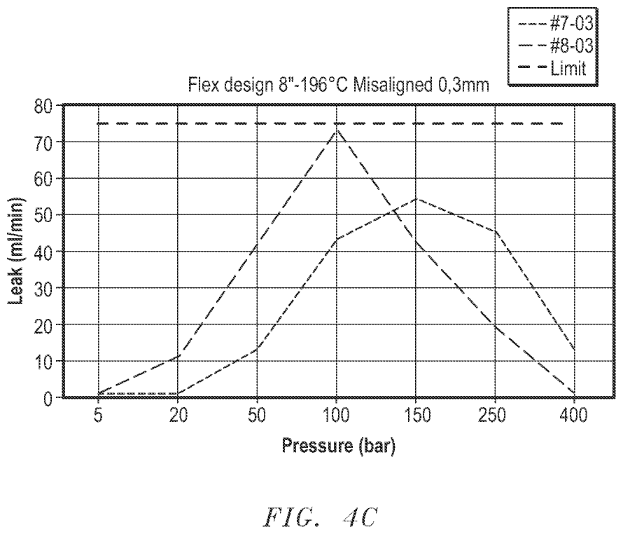

FIG. 4A shows the leak performance data for multiple tests of an embodiment of a seal 200 for the aligned condition. FIG. 4B shows the leak performance data for multiple tests of an embodiment of a seal 200 for the 0.2 mm misaligned condition. FIG. 4C shows the leak performance data for multiple tests of an embodiment of a seal 200 for the 0.3 mm misaligned condition. As shown in FIG. 4A, it can be seen that the performance under aligned conditions is relatively constant and passes the 25% limit of the Shell 300 Specification. As shown in FIG. 4B, it can be seen that the performance in the 0.2 mm misaligned condition passes the 25% limit of the Shell 300 Specification. As shown in FIG. 4C, it can be seen that the performance in the 0.3 mm misaligned condition passes the 25% limit of the Shell 300 Specification.

Embodiments of the valve 100 and/or the seal 200 may include, inter alia, one or more of the following items:

Embodiment 1. A seal, comprising: a seal body, comprising: a heel; an upper leg and a lower leg each extending from the heel; and a cavity formed between the upper leg and the lower leg and comprising a first cavity portion and a second cavity portion; and an energizing element disposed within the first cavity portion.

Embodiment 2. The seal of embodiment 1, wherein the upper leg comprises an upper surface extending from the heel and an upper contact surface, and wherein the lower leg comprises a lower surface extending from the heel and a lower contact surface.

Embodiment 3. The seal of embodiment 2, wherein each of the upper leg and the lower leg extend orthogonally from the heel.

Embodiment 4. The seal of any of embodiments 2 to 3, wherein the upper contact surface and the lower contact surface are substantially parallel.

Embodiment 5. The seal of any of embodiments 2 to 4, wherein the seal comprises a larger overall height measured between the upper contact surface and the lower contact surface as compared to the overall height measured between the upper surface and the lower surface.

Embodiment 6. The seal of any of embodiments 1 to 5, wherein the first cavity portion comprises an opening.

Embodiment 7. The seal of embodiment 6, wherein the opening is defined between an upper opening surface of the upper leg and a lower opening surface of the lower leg.

Embodiment 8. The seal of embodiment 7, wherein the first cavity portion comprises an upper curved surface extending from the upper opening surface to the second cavity portion and a lower curved surface extending from the lower opening surface to the second cavity portion.

Embodiment 9. The seal of embodiment 8, wherein the upper curved surface and the lower curved surface are symmetrical about a horizontal centerline that extends through the center of the seal.

Embodiment 10. The seal of any of embodiments 8 to 9, wherein the upper curved surface and the lower curved surface comprise substantially equal radii.

Embodiment 11. The seal of any of embodiments 8 to 10, wherein the upper curved surface and the lower curved surface comprise substantially equal curve lengths.

Embodiment 12. The seal of any of embodiments 8 to 11, wherein the first cavity portion is configured to receive the energizing element and capture the energizing element between the upper curved surface and the lower curved surface.

Embodiment 13. The seal of embodiment 12, wherein the upper curved surface and the lower curved surface comprise a larger radius than that of the energizing element.

Embodiment 14. The seal of any of embodiments 1 to 13, wherein the energizing element is formed from titanium, stainless steel, steel, Inconel®, Elgiloy®, Hastelloy®, other resilient metallic materials, or any combination thereof.

Embodiment 15. The seal of any of embodiments 1 to 14, wherein the second cavity portion is formed between the first cavity portion and the heel.

Embodiment 16. The seal of any of embodiments 8 to 15, wherein the second cavity portion comprises an upper surface extending towards the heel from the upper curved surface to the vertical wall, an opposing lower surface extending towards the heel from the lower curved surface to the vertical wall, and a vertical wall disposed between the upper surface and the lower surface and opposite the opening of the first cavity portion.

Embodiment 17. The seal of embodiment 16, wherein the vertical wall is substantially parallel to the heel.

Embodiment 18. The seal of embodiment 17, wherein the upper surface and the lower surface are substantially parallel.

Embodiment 19. The seal of embodiment 18, wherein the vertical wall is substantially orthogonal to each of the upper surface and the lower surface.

Embodiment 20. The seal of any of embodiments 1 to 19, wherein the second cavity portion is free of an energizing element.

Embodiment 21. The seal of any of embodiments 16 to 20, wherein an overall height of the opening as measured between the upper opening surface and the lower opening surface is larger than the overall height of the second cavity portion as measured between the upper surface and the lower surface.

Embodiment 22. The seal of any of embodiments 1 to 21, wherein a depth of the second cavity portion is at least 25%, at least 50%, at least 55%, at least 60%, at least 65%, at least 70%, at least 75%, at least 80%, at least 90%, at least 95%, or at least 100% of the depth of the first cavity portion.

Embodiment 23. The seal of embodiment 22, wherein the depth of the second cavity portion is not greater than 200%, not greater than 150%, not greater than 125%, or not greater than 100% of the depth of the first cavity portion.

Embodiment 24. The seal of any of embodiments 1 to 23, wherein the depth of the second cavity portion is at least 5%, at least 10%, at least 15%, at least 20%, at least 30%, at least 35%, or at least 40% of the overall length of the seal.

Embodiment 25. The seal of embodiment 24, wherein the depth of the second cavity portion is not greater than 80%, not greater than 75%, not greater than 70%, not greater than 65%, not greater than 60%, not greater than 55%, not greater than 50%, not greater than 45%, or not greater than 40% of the length of the overall length of the seal.

Embodiment 26. The seal of any of embodiments 1 to 25, wherein as compared to a traditional seal without a second cavity portion, the seal increases a contact pressure at each of the upper contact surface and the lower contact surface by at least 5%, at least 10%, at least 15%, at least 20%, at least 25%, at least 30%, at least 35%, at least 40%, at least 45%, at least 50%, at least 75%, at least 95%, at least 100%, at least 125%, or at least 150%.

Embodiment 27. The seal of embodiment 26, wherein the seal increases a contact pressure at each of the upper contact surface and the lower contact surface by not greater than 500%, not greater than 400%, not greater than 300%, not greater than 200%, or not greater than 100%.

Embodiment 28. The seal of any of embodiments 1 to 27, wherein the seal conforms to a 25% limit of a Shell 300 Specification for leakage in each of an aligned condition and a misaligned condition.

Embodiment 29. A valve, comprising: a valve body; a ball selectively rotatable within the valve body; a seat having a seat insert at disposed within the valve body and configured to form a seal with the ball; and a seal disposed within a cavity formed between the valve body and the seat, wherein the seal comprises: a seal body, comprising: a heel; an upper leg and a lower leg extending from the heel; and a cavity comprising a first cavity portion and a second cavity portion disposed between the upper leg and the lower leg; and an energizing element disposed within the first cavity portion.

Embodiment 30. The valve of embodiment 29, wherein the upper leg comprises an upper surface extending from the heel and an upper contact surface, and wherein the lower leg comprises a lower surface extending from the heel and a lower contact surface.

Embodiment 31. The valve of embodiment 30, wherein each of the upper leg and the lower leg extend orthogonally from the heel.

Embodiment 32. The valve of any of embodiments 30 to 31, wherein the upper contact surface and the lower contact surface are substantially parallel.

Embodiment 33. The valve of any of embodiments 30 to 32, wherein the seal comprises a larger overall height measured between the upper contact surface and the lower contact surface as compared to the overall height measured between the upper surface and the lower surface.

Embodiment 34. The valve of any of embodiments 29 to 33, wherein the first cavity portion comprises an opening.

Embodiment 35. The valve of embodiment 34, wherein the opening is defined between an upper opening surface of the upper leg and a lower opening surface of the lower leg.

Embodiment 36. The valve of embodiment 35, wherein the first cavity portion comprises an upper curved surface extending from the upper opening surface to the second cavity portion and a lower curved surface extending from the lower opening surface to the second cavity portion.

Embodiment 37. The valve of embodiment 36, wherein the upper curved surface and the lower curved surface are symmetrical about a horizontal centerline that extends through the center of the seal.

Embodiment 38. The valve of any of embodiments 36 to 37, wherein the upper curved surface and the lower curved surface comprise substantially equal radii.

Embodiment 39. The valve of any of embodiments 36 to 38, wherein the upper curved surface and the lower curved surface comprise substantially equal curve lengths.

Embodiment 40. The valve of any of embodiments 36 to 39, wherein the first cavity portion is configured to receive the energizing element and capture the energizing element between the upper curved surface and the lower curved surface.

Embodiment 41. The valve of embodiment 40, wherein the upper curved surface and the lower curved surface comprise a larger radius than that of the energizing element.

Embodiment 42. The valve of embodiment 41, wherein the energizing element confirms to the upper curved surface and the lower curved surface under deformation, misalignment, or pressurization in the valve.

Embodiment 43. The valve of any of embodiments 29 to 42, wherein the energizing element is formed from titanium, stainless steel, steel, Inconel®, Elgiloy®, Hastelloy®, other resilient metallic materials, or any combination thereof.

Embodiment 44. The valve of any of embodiments 29 to 43, wherein the second cavity portion is formed between the first cavity portion and the heel.

Embodiment 45. The valve of any of embodiments 36 to 44, wherein the second cavity portion comprises an upper surface extending towards the heel from the upper curved surface to the vertical wall, an opposing lower surface extending towards the heel from the lower curved surface to the vertical wall, and a vertical wall disposed between the upper surface and the lower surface and opposite the opening of the first cavity portion.

Embodiment 46. The valve of embodiment 45, wherein the vertical wall is substantially parallel to the heel.

Embodiment 47. The valve of embodiment 46, wherein the upper surface and the lower surface are substantially parallel.

Embodiment 48. The valve of embodiment 47, wherein the vertical wall is substantially orthogonal to each of the upper surface and the lower surface.

Embodiment 49. The valve of any of embodiments 29 to 48, wherein the second cavity portion is free of an energizing element.

Embodiment 50. The valve of any of embodiments 47 to 49, wherein the upper surface and the lower surface angle inward under deformation, misalignment, or pressurization in the valve.

Embodiment 51. The valve of any of embodiments 45 to 50, wherein an overall height of the opening as measured between the upper opening surface and the lower opening surface is larger than the overall height of the second cavity portion as measured between the upper surface and the lower surface.

Embodiment 52. The valve of any of embodiments 29 to 51, wherein a depth of the second cavity portion is at least 25%, at least 50%, at least 55%, at least 60%, at least 65%, at least 70%, at least 75%, at least 80%, at least 90%, at least 95%, or at least 100% of the depth of the first cavity portion.

Embodiment 53. The valve of embodiment 52, wherein the depth of the second cavity portion is not greater than 200%, not greater than 150%, not greater than 125%, or not greater than 100% of the depth of the first cavity portion.

Embodiment 54. The valve of any of embodiments 29 to 53, wherein the depth of the second cavity portion is at least 5%, at least 10%, at least 15%, at least 20%, at least 30%, at least 35%, or at least 40% of the overall length of the seal.

Embodiment 55. The valve of embodiment 54, wherein the depth of the second cavity portion is not greater than 80%, not greater than 75%, not greater than 70%, not greater than 65%, not greater than 60%, not greater than 55%, not greater than 50%, not greater than 45%, or not greater than 40% of the length of the overall length of the seal.

Embodiment 56. The valve of any of embodiments 29 to 55, wherein as compared to a traditional seal without a second cavity portion, the seal increases a contact pressure at each of the upper contact surface and the lower contact surface by at least 5%, at least 10%, at least 15%, at least 20%, at least 25%, at least 30%, at least 35%, at least 40%, at least 45%, at least 50%, at least 75%, at least 95%, at least 100%, at least 125%, or at least 150%.

Embodiment 57. The valve of embodiment 56, wherein the seal increases a contact pressure at each of the upper contact surface and the lower contact surface by not greater than 500%, not greater than 400%, not greater than 300%, not greater than 200%, or not greater than 100%.

Embodiment 58. The valve of any of embodiments 29 to 57, wherein the seal conforms to a 25% limit of a Shell 300 Specification for leakage in each of an aligned condition and a misaligned condition.

Embodiment 59. The seal of any of embodiments 1 to 28 or the valve of any of embodiments 29 to 58, wherein the seal body is formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof.

Embodiment 60. The seal of any of embodiments 1 to 28 and 59 or the valve of any of embodiments 29 to 59, wherein the upper surface and the lower surface are substantially curved.

Embodiment 61. The seal or the valve of embodiment 60, wherein the second cavity comprises an energizing element.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. An annular seal, comprising:
a seal body, comprising:
a heel;
an upper leg and a lower leg each extending from the heel; and
a cavity formed between the upper leg and the lower leg and comprising a first cavity portion and a second cavity portion; and
an energizing element disposed within the first cavity portion.

2. The seal of claim 1, wherein the upper leg comprises an upper surface extending from the heel and an upper contact surface, and wherein the lower leg comprises a lower surface extending from the heel and a lower contact surface.

3. The seal of claim 2, wherein the seal comprises a larger overall height measured between the upper contact surface and the lower contact surface as compared to the overall height measured between the upper surface and the lower surface.

4. The seal of claim 1, wherein the first cavity portion comprises an opening.

5. The seal of claim 4, wherein the opening is defined between an upper opening surface of the upper leg and a lower opening surface of the lower leg.

6. The seal of claim 5, wherein an overall height of the opening as measured between the upper opening surface and the lower opening surface is larger than the overall height of the second cavity portion as measured between an upper surface and a lower surface of the second cavity portion.

7. The seal of claim 5, wherein the first cavity portion comprises an upper curved surface extending from the upper opening surface to the second cavity portion and a lower curved surface extending from the lower opening surface to the second cavity portion.

8. The seal of claim 7, wherein the first cavity portion is configured to receive the energizing element and capture the energizing element between the upper curved surface and the lower curved surface.

9. The seal of claim 8, wherein the upper curved surface and the lower curved surface comprise a larger radius than that of the energizing element.

10. The seal of claim 1, wherein the second cavity portion is free of an energizing element.

11. The seal of claim 1, wherein the second cavity portion is formed between the first cavity portion and the heel.

12. The seal of claim 11, wherein the second cavity portion comprises an upper surface extending towards the heel from the upper curved surface to the vertical wall, an opposing lower surface extending towards the heel from the lower curved surface to the vertical wall, and a vertical wall disposed between the upper surface and the lower surface and opposite the opening of the first cavity portion.

13. The seal of claim 12, wherein the upper surface and the lower surface are substantially parallel, curved, or a combination thereof.

14. The seal of claim 13, wherein the vertical wall is substantially parallel to the heel.

15. The seal of claim 1, wherein a depth of the second cavity portion is at least 25%, at least 50%, at least 55%, at least 60%, at least 65%, at least 70%, at least 75%, at least 80%, at least 90%, at least 95%, or at least 100% of the depth of the first cavity portion, and wherein the depth of the second cavity portion is not greater than 200%, not greater than 150%, not greater than 125%, or not greater than 100% of the depth of the first cavity portion.

16. The seal of claim 1, wherein the depth of the second cavity portion is at least 5%, at least 10%, at least 15%, at least 20%, at least 30%, at least 35%, or at least 40% of the overall length of the seal, and wherein the depth of the second cavity portion is not greater than 80%, not greater than 75%, not greater than 70%, not greater than 65%, not greater than 60%, not greater than 55%, not greater than 50%, not greater than 45%, or not greater than 40% of the length of the overall length of the seal.

17. The seal of claim 1, wherein as compared to a traditional seal without a second cavity portion, the seal increases a contact pressure at each of the upper contact surface and the lower contact surface by at least 5%, at least 10%, at least 15%, at least 20%, at least 25%, at least 30%, at least 35%, at least 40%, at least 45%, at least 50%, at least 75%, at least 95%, at least 100%, at least 125%, or at least 150%, and wherein the seal increases a contact pressure at each of the upper contact surface and the lower contact surface by not greater than 500%, not greater than 400%, not greater than 300%, not greater than 200%, or not greater than 100%.

18. The seal of claim 1, wherein the seal conforms to a 25% limit of a Shell 300 Specification for leakage in each of an aligned condition and a misaligned condition.

19. The seal of claim 1, wherein the seal body is formed from PTFE, a fluoropolymer, a perfluoropolymer, PTFE, TFM, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI or TPI, or any combination thereof.

20. The seal of claim 1, wherein the energizing element is formed from titanium, stainless steel, steel, Inconel®, Elgiloy®, Hastelloy®, other resilient metallic materials, or any combination thereof.
